(19) United States
(12) Patent Application Publication
(10) Pub. No.: US 2022/0172226 A1
(43) Pub. Date: Jun. 2, 2022

(54) SYSTEM AND METHOD FOR AUTOMATED RECOMMENDATIONS OF COMPETITORS FOR SALES OPPORTUNITIES BASED ON BUSINESS SCENARIO, CUSTOM INPUT AND USER FEEDBACK

(71) Applicant: Aviso, Inc., Redwood City, CA (US)

(72) Inventors: Joy MUSTAFI, Hyderabad (IN); Sayan Deb KUNDU, Kolkata (IN); Kanishka DHAMIJA, Indore (IN); Trevor RODRIGUES, Scottsdale (US)

(73) Assignee: Aviso, Inc., Redwood City, CA (US)

(21) Appl. No.: 17/110,079

(22) Filed: Dec. 2, 2020

(51) Int. Cl. G06Q 30/02; G06Q 30/00; G06Q 10/06; G06Q 10/10; G06F 16/953; G06N 20/00; G06N 5/04

(52) U.S. Cl. CPC G06Q 30/0201; G06Q 30/016; G06Q 10/06315; G06N 5/04; G06Q 10/107; G06F 16/953; G06N 20/00; G06Q 10/06375

(57) ABSTRACT

A system and method for automated recommendations of competitors for sales opportunities. The system includes a customer relationship management database, a calls log and email database, an enterprise resource planning database, an external public server, a system server, and a sales representative device. The system server includes server processing unit, and a server memory. The server processing unit executes computer-readable instructions to receive direct signal and indirect signal of competitors related to particular sales opportunities from customer relationship management database and the enterprise resource planning database. Further the server processing unit uses the trained machine learning model to receive indirect signals of competitors related to particular deals from the calls log and email database. The server processing unit uses the trained machine learning model to extract data of competitors related to particular deals from the external public server.

### FIELD OF INVENTION

The present invention relates to a system and methods for automated recommendations of competitors, and more specifically relates to a system and method for automated recommendations of competitors for sales opportunities based on business scenario, custom input and user feedback.

Multiple companies have been operating in the same field nowadays. Thus there is huge competition in the market. The companies have to even with a slight delay in making the decision, results in loss of the sales deals. If there is a large company, then it is also difficult to make a decision quickly. Some it is difficult to find under performance of sales representatives and factors affecting sales representative performance. Thus ultimately the sales target of a particular sales representative does not achieve. To manage customer and sales, there is a CRM system.

Customer relationship management (CRM) is one of many different approaches that allow a company to manage and analyze its own interactions with its past, current and potential customers. It uses data analysis about customers' history with a company to improve business relationships with customers, specifically focusing on customer retention and ultimately driving sales growth. It is used by the sales team of an organization and stores a list of opportunities. Opportunities are past or pending sales for an account that you want to work and/or track. Opportunities plays major role in an organization because they represent sales and potential sales. A sales opportunity is a qualified prospect that has a high probability of becoming a customer. Opportunities in CRM have some attributes that define the status of the opportunity. One of the attributes of an opportunity is “competitor” which is the companies who offer the same products and services aimed at the same target market and customer base. Primary competitor is the main competitor against whom the opportunity is at a risk of losing and it improves the chances of winning a potential customer if the primary competitor is known to the sales representative targeting the opportunity.

Patent US10504127B2 discloses that competitors are classified in terms of products the competitors offer. A product set is generated from product information received from a user. Also, a competitor set is generated, where the competitor set comprises at least one competitor determined to be relevant to one or more products in the product set. A target price rule is generated that is operative to change a price offered by the user for the at least one product. A competitors relevancy can be determined by considering factors such as: (1) unique visitors to the competitor's website, (2) reviews on the competitor's website (3), ratings on the competitor's website, (4) absolute number of products common to the user's website and the competitor's website, (5) percentage number of products common to the user's website and the competitor's website, and (6) number of products offered by the competitor that comprise the product set.

The existing invention does not provide alerts related to competitors. The existing inventions do not look at the competitors at opportunity level to identify the competitors at opportunity level which would be helpful to the sales representatives in order to get better knowledge in order to help win the opportunity. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a method for automated recommendations of competitors for sales opportunities based on business scenario, custom input and user feedback, the method includes: A method of recommending primary competitor list using direct signal from the customer relationship management database, and the enterprise resource planning database, the method having: A server processing unit of a system server, executes computer-readable instructions that retrieve data related to historical sales opportunities from a customer relationship management database, CPQ system, and an enterprise resource planning database. The server processing unit executes computer-readable instructions to identify a list of sales opportunities from the historical sales opportunities that are similar to the current sales opportunities. The server processing unit executes computer-readable instructions to find a list of competitors from the identified list of sales opportunities from the historical sales opportunities that are similar to the current sales opportunities. In case there is more than one competitor in the list of competitors, then that one competitor is categorized as primary competitor that has majority count in list of sales opportunities from the historical sales opportunities that are similar to the current sales opportunities, and further primary competitor is added to a primary competitor list. In case there is only one competitor in the list, then that one competitor is added as the primary competitor to the primary competitor list. Thus the server processing unit executes computer-readable instructions and recommends the primary competitor list using direct signal to the sales representative on a sales representative device that improves the chances of winning a potential customer.

A method of recommending primary competitor list in case of no direct signal of competitors are found in the customer relationship management database, CPQ system and the enterprise resource planning database, the method having: The server processing unit of the system server executes computer-readable instructions to retrieve data related to historical sales opportunities from the customer relationship management database, CPQ system and the enterprise resource planning database, and feed into the trained machine learning model. The server processing unit uses the trained machine learning model to analyze and retrieve data to find indirect signals of one or more competitors in the historical sales opportunities that are similar to current sales opportunities. In case the trained machine learning model finds indirect signal of one or more competitors, then that one competitor out of one or more competitors is categorized as primary competitor that has majority count in list of sales opportunities from the historical sales opportunities that are similar to the current sales opportunities, and further primary competitor is added to primary competitor list. Thus, the server processing unit executes computer-readable instructions and recommends primary competitor list using indirect signal to sales representative on a sales representative device that improves the chances of winning a potential customer.

A method of recommending primary competitor list in case of not finding even indirect signal of competitor from the customer relationship management database, CPQ system and the enterprise resource planning database, the method having: The server processing unit uses the trained machine learning model retrieve data related to a historical conversation on emails and calls with customers from the calls log and email database. The server processing unit uses the trained machine learning model to analyze data related to a historical conversation on emails and calls with customers to find indirect signals of one or more competitors. In case the trained machine learning model finds indirect signals of one or more competitors, then that one competitor, out of one or more competitors, is categorized as primary competitor that has majority count, and further primary competitor is added to primary competitor list. Thus, the server processing unit executes computer-readable instructions and recommends primary competitor list using indirect signal to sales representative on the sales representative device that improves the chances of winning a potential customer.

A method of recommending primary competitor list in case of not finding even indirect signal of competitor from the calls log and email database, the method having: The server processing unit uses the trained machine learning model to crawl the external public server and search for competitor that are looking for sales opportunities that are similar to the current sales opportunities of the sales representative. In case the trained machine learning model found competitors that are looking for sales opportunities that are similar to the current sales opportunities of the sales representative, then add that competitor to the primary competitor list. Thus the server processing unit executes computer-readable instructions and recommends primary competitor list using indirect signal to sales representative on the sales representative device that improves the chances of winning a potential customer.

The main advantage of the present invention is that the present invention provides a statistically verifiable solution which has yielded positive results.

Yet another advantage of the present invention is that the present invention automates recommendations of competitors for sales opportunities

Yet another advantage of the present invention is that the present invention helps the sales representative to decide a competitive price for the opportunity so that it can be converted to a customer.

Yet another advantage of the present invention is that the present invention helps the sales representative to prioritize: the opportunity to focus on in case the competitor is active.

Yet another advantage of the present invention is that the present invention helps convey to the prospect as to how the sales representatives offer better services than the others.

Further objectives, advantages, and features of the present invention will become apparent from the detailed description provided hereinbelow, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the architecture of the present invention.

FIG. 3 illustrates the system of the present invention

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A. B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

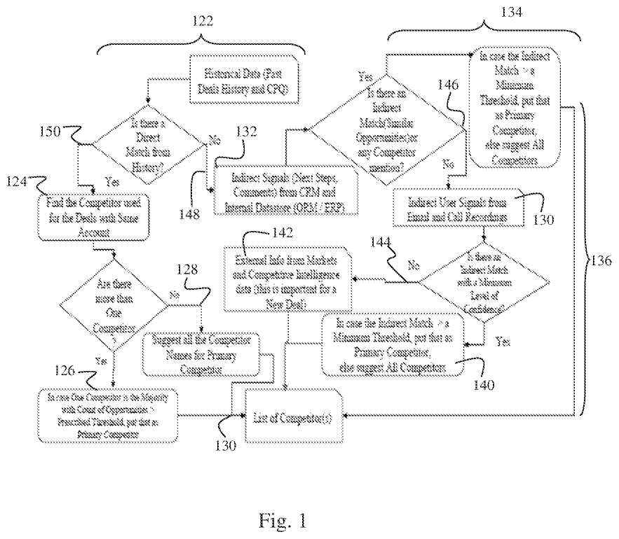

FIG. 1 illustrates flow chart of a method for automated recommendations of competitors for sales opportunities based on business scenario, custom input and user feedback. In step (150), a method of recommending primary competitor list using direct signal from the customer relationship management database (102), and the enterprise resource planning database (110), having: In step (122), a server processing unit (106) of a system server (104), executes computer-readable instructions that retrieve data related to historical sales opportunities from a customer relationship management database (102), a CPQ system (116), and an enterprise resource planning database (110). In step (124), the server processing unit (106) executes computer-readable instructions to identify a list of sales opportunities from the historical sales opportunities that are similar to the current sales opportunities. In step (126), in case there is more than one competitor in the list of competitors, then that one competitor is categorized as primary competitor that has majority count in list of sales opportunities from the historical sales opportunities that are similar to the current sales opportunities, and further primary competitor is added to a primary competitor list. In step (128), in case there is only one competitor in the list, then that one competitor is added as the primary competitor to the primary competitor list. In step (130). Thus the server processing unit (106) executes computer-readable instructions and recommends primary competitor list using direct signal to sales representative on a sales representative device (112), which improves the chances of winning a potential customer.

In 148, a method of recommending primary competitor list in case of no direct signal of competitors are found in the customer relationship management database (102), a CPQ system (116), and the enterprise resource planning database (110), having: In step (132), the server processing unit (106) of the system server (104) executes computer-readable instructions to retrieve data related to historical sales opportunities from the customer relationship management database (102), a CPQ system (116), and the enterprise resource planning database (110), and feed into the trained machine learning model. The server processing unit (106) uses the trained machine learning model to analyze and retrieve data to find indirect signals of one or more competitors in the historical sales opportunities that are similar to current sales opportunities. In step (134), In case the trained machine learning model finds indirect signal of one or more competitors, then that one competitor out of one or more competitors is categorized as primary competitor that has majority count in list of sales opportunities from the historical sales opportunities that are similar to the current sales opportunities, and further primary competitor is added to primary competitor list. In step (136). Thus the server processing unit (106) executes computer-readable instructions and recommends primary competitor list using indirect signal to sales representative on a sales representative device (112), which improves the chances of winning a potential customer.

In (146), a method of recommending primary competitor list in case of not finding even indirect signal of competitor from the customer relationship management database (102), and the enterprise resource planning database (110), having: In step (138), the server processing unit (106) uses the trained machine learning model retrieve data related to a historical conversation on emails and calls with customers from the calls log and email database (108). The server processing unit (106) uses the trained machine learning model to analyze data related to a historical conversation on emails and calls with customers to find indirect signals of one or more competitors. In step (140), in case the trained machine learning model finds indirect signal of one or more competitors, then that one competitor, out of one or more competitors, is categorized as primary competitor that has majority, count, and further primary competitor is added to primary competitor list. Thus the server processing unit (106) executes computer-readable instructions and recommends primary competitor list using indirect signal to sales representative on the sales representative device (112), which improves the chances of winning a potential customer.

In (144), A method of recommending primary competitor list in case of not finding even indirect signal of competitor from the calls log and email database (108), having: In step (142), the server processing unit (106) uses the trained machine learning model to crawl the external public server (114) and search for competitor that are looking for sales opportunities that are similar to the current sales opportunities of the sales representative. In case the trained machine learning model found competitors that are looking for sales opportunities that are similar to the current sales opportunities of the sales representative, then add that competitor to the primary competitor list. Thus the server processing unit (106) executes computer-readable instructions and recommends primary competitor list using indirect signal to sales representative on the sales representative device (112), which improves the chances of winning a potential customer.

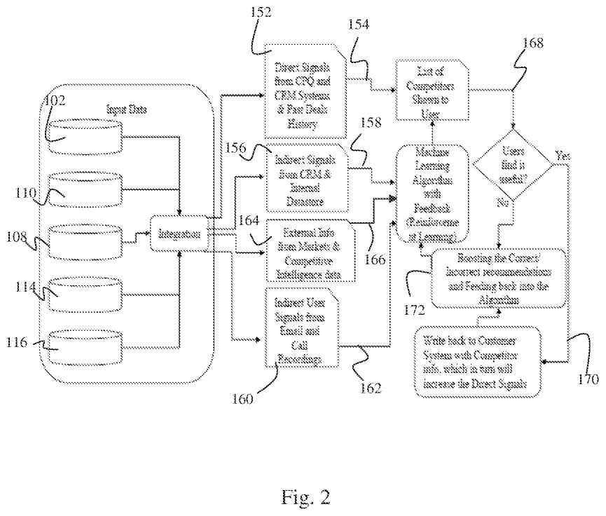

FIG. 2 illustrates architecture for automated recommendations of competitors for sales opportunities based on business scenario, custom input and user feedback. In step (152), a server processing unit (106) of a system server (104), executes computer-readable instructions that retrieve data related to historical sales opportunities from a customer relationship management database (102), a CPQ system (116), and an enterprise resource planning database (110). In step (154), the server processing unit (106) executes computer-readable instructions to identify a list of sales opportunities from the historical sales opportunities that are similar to the current sales opportunities, and further primary competitor is added to a primary competitor list.

In step (156), the server processing unit (106) of the system server (104) executes computer-readable instructions to retrieve data related to historical sales opportunities from the customer relationship management database (102), a CPQ system (116), and the enterprise resource planning database (110), and feed into the trained machine learning model. In step (158), the server processing unit (106) uses the trained machine learning model to analyze retrieve data to find indirect signal of one or more competitors in the historical sales opportunities that are similar to current sales opportunities, and further primary competitor is added to primary competitor list.

In step (160), the server processing unit (106) uses the trained machine learning model to retrieve data related to a historical conversation on emails and calls with customers from the calls log and email database (108). In step (162), the server processing unit (106) uses the trained machine learning model to analyze data related to a historical conversation on emails and calls with customers to find indirect signal of one or more competitors, and further primary competitor is added to primary competitor list.

In step (164), the server processing unit (106) uses the trained machine learning model to crawl the external public server (114) and search for competitor that are looking for sales opportunities that are similar to the current sales opportunities of the sales representative. In step (166), in case the trained machine learning model found competitor that are looking for sales opportunities that are similar to the current sales opportunities of the sales representative, then add that competitor to primary competitor list. In step (168), thus the server processing unit (106) executes computer-readable instructions and recommends primary competitor list using indirect signal to sales representative on the sales representative device (112), which improves the chances of winning a potential customer. In step (170), on receiving primary competitor list, if the sales representative found primary competitor list is useful, then update same list on the on the customer relationship management database (102) that is helpful to get direct signals from the customer relationship management database (102). In step (172), the at least one server processing unit (106) uses data of both primary useful and non-useful competitor from primary competitor list to train machine learning model.

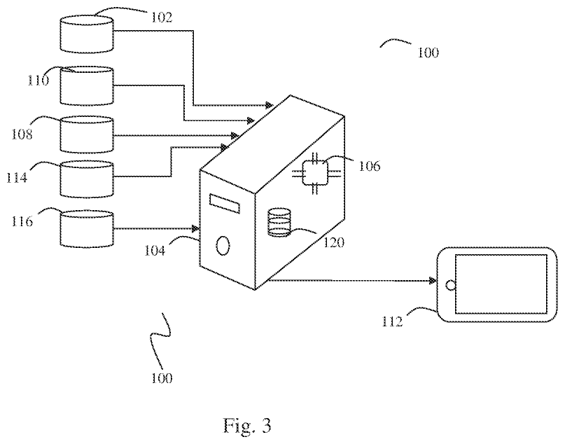

FIG. 3 illustrates a system (100) for automated recommendations of competitors for sales opportunities based on business scenario, custom input and user feedback. The system (100) includes a customer relationship management database (102), a calls log and email database (108), an enterprise resource planning database (110), an external public server (114), a CPQ system (116), a system server (104), and a sales representative device (112). The system server (104) includes server processing unit (106), and a server memory (120). The sales representative device (112) is connected to the system server (104).

The present invention relates to a method for automated recommendations of competitors for sales opportunities based on business scenario, custom input and user feedback, the method includes:

A method of recommending primary competitor list using direct signal from the customer relationship management database, CPQ system and the enterprise resource planning database, the method having:

a server processing unit of a system server, executes computer-readable instructions that retrieve data related to historical sales opportunities from a customer relationship management database, CPQ system and an enterprise resource planning database;

the server processing unit executes computer-readable instructions to identify a list of sales opportunities from the historical sales opportunities that are similar to the current sales opportunities;

the server processing unit executes computer-readable instructions to find list of competitors from the identified list of sales opportunities from the historical sales opportunities that are similar to the current sales opportunities;

in case there is more than one competitors in the list of competitors, then that one competitor is categorized as primary competitor that has majority count in list of sales opportunities from the historical sales opportunities that are similar to the current sales opportunities, and further primary competitor is added to a primary competitor list;

in case there is only one competitor in the list, then that one competitor is added as primary competitor to the primary competitor list; and

Thus the server processing unit executes computer-readable instructions and recommends the primary competitor list using direct signal to sales representative on a sales representative device, which improves the chances of winning a potential customer.

In an embodiment, the server processing unit uses multiple similarity measures, classification and clustering algorithms identify a list of sales opportunities from the historical sales opportunities that are similar to the current sales opportunities.

A method of recommending primary competitor list in case of no direct signal of competitors are found in the customer relationship management database, CPQ system and the enterprise resource planning database, the method having:

The server processing unit of the system server executes computer-readable instructions to retrieve data related to historical sales opportunities from the customer relationship management database, CPQ system and the enterprise resource planning database, and feed into the trained machine learning model;

the server processing unit uses the trained machine learning model to analyze retrieve data to find indirect signal of one or more competitors in the historical sales opportunities that are similar to current sales opportunities;

in case the trained machine learning model finds indirect signal of one or more competitors, then that one competitor out of one or more competitors is categorized as primary competitor that has majority count in list of sales opportunities from the historical sales opportunities that are similar to the current sales opportunities, and further primary competitor is added to primary competitor list; and

Thus the server processing unit executes computer-readable instructions and recommends primary competitor list using indirect signal to sales representative on a sales representative device, which improves the chances of winning a potential customer.

In an embodiment, data that are being extracted from the customer relationship management database, CPQ system and the enterprise resource planning database are including, but not limited to, a historical record of historical and current sales opportunities data, direct as well as indirect signals from CPQ systems.

A method of recommending primary competitor list in case of not finding even indirect signal of competitor from the customer relationship management database, CPQ system and the enterprise resource planning database, the method having:

The server processing unit uses the trained machine learning model retrieve data related to a historical conversation on email s and calls with customers from the calls log and email database;

the server processing unit uses the trained machine learning model to analyze data related to a historical conversation on emails and calls with customers to find indirect signal of one or more competitors;

in case the trained machine learning model finds indirect signal of one or more competitors, then that one competitor, out of one or more competitors, is categorized as primary competitor that has majority count, and further primary competitor is added to primary competitor list; and

Thus the server processing unit executes computer-readable instructions and recommends primary competitor list using indirect signal to sales representative on the sales representative device, which improves the chances of winning a potential customer.

In an embodiment, data that are being extracted from the calls log and email database are including, but not limited to, email and call recordings of sales representatives.

A method of recommending primary competitor list in case of not finding even indirect signal of competitor from the calls log and email database, the method having:

The server processing unit uses the trained machine learning model to crawl the external public server and search for competitor that are looking for sales opportunities that are similar to the current sales opportunities of the sales representative;

in case the trained machine learning model found competitor that are looking for sales opportunities that are similar to the current sales opportunities of the sales representative, then add that competitor to primary competitor list; and

Thus the server processing unit executes computer-readable instructions and recommends primary competitor list using indirect signal to sales representative on the sales representative device, which improves the chances of winning a potential customer.

In an embodiment, the external public server is a public internet that hosts different web pages that are being crawled by the machine learning model of the server processing unit to extract data of competitors related to sales opportunities.

In an embodiment, on receiving a primary competitor list, if the sales representative found the primary competitor list is useful, then update the same list on the on the customer relationship management database that is helpful to get direct signals from the customer relationship management database and further the server processing unit primary competitor list.

In an embodiment, the present invention relates to a method for automated recommendations of competitors for sales opportunities based on business scenario, custom input and user feedback, the method includes:

A method of recommending primary competitor list using direct signal from the customer relationship management database, CPQ system and the enterprise resource planning database, the method having:

one or more server processing units of a system server, execute computer-readable instructions that retrieve data related to historical sales opportunities from a customer relationship management database, CPQ system and an enterprise resource planning database;

the one or more server processing units execute computer-readable instructions to identify a list of sales opportunities from the historical sales opportunities that are similar to the current sales opportunities;

the one or more server processing units execute computer-readable instructions to find list of competitors from the identified list of sales opportunities from the historical sales opportunities that are similar to the current sales opportunities;

in case there is more than one competitors in the list of competitors, then that one competitor is categorized as primary competitor that has majority count in list of sales opportunities from the historical sales opportunities that are similar to the current sales opportunities, and further primary competitor is added to a primary competitor list;

in case there is only one competitor in the list, then that one competitor is added as primary competitor to the primary competitor list; and

Thus the one or more server processing units execute computer-readable instructions and recommend the primary competitor list using direct signal to sales representative on one or more sales representative devices, which improves the chances of winning a potential customer.

In an embodiment, the one or more server processing units use multiple similarity measures, classification and clustering algorithms identify a list of sales opportunities from the historical sales opportunities that are similar to the current sales opportunities.

A method of recommending primary competitor list in case of no direct signal of competitors are found in the customer relationship management database, CPQ system and the enterprise resource planning database, the method having:

The one or more server processing units of the system server execute computer-readable instructions to retrieve data related to historical sales opportunities from the customer relationship management database, CPQ system and the enterprise resource planning database, and feed into the trained machine learning model;

the one or more server processing units use the trained machine learning model to analyze retrieve data to find indirect signal of one or more competitors in the historical sales opportunities that are similar to current sales opportunities;

in case the trained machine learning model finds indirect signal of one or more competitors, then that one competitor out of one or more competitors are categorized as primary competitor that has majority count in list of sales opportunities from the historical sales opportunities that are similar to the current sales opportunities, and further primary competitor is added to primary competitor list; and

Thus the one or more server processing units execute computer-readable instructions and recommend a primary competitor list using indirect signal to sales representative on one or more sales representative devices, which improves the chances of winning a potential customer.

In an embodiment, data that are being extracted from the customer relationship management database, CPQ system and the enterprise resource planning database are including, but not limited to, a historical record of historical and current sales opportunities data, direct as well as indirect signals from CPQ systems.

A method of recommending primary competitor list in case of not finding even indirect signal of competitor from the customer relationship management database, CPQ system and the enterprise resource planning database, the method having:

The one or more server processing units use the trained machine learning model retrieve data related to a historical conversation on emails and calls with customers from the calls log and email database;

the one or more server processing units use the trained machine learning model to analyze data related to a historical conversation on emails and calls with customers to find indirect signal of one or more competitors;

in case the trained machine learning model finds indirect signal of one or more competitors, then that one competitor, out of one or more competitors, are categorized as primary competitor that has majority count, and further primary competitor is added to primary competitor list; and

Thus the one or more server processing units execute computer-readable instructions and recommend a primary competitor list using indirect signal to sales representative on one or more sales representative devices, which improves the chances of winning a potential customer.

In an embodiment, data that are being extracted from the calls log and email database are including, but not limited to, email and call recordings of sales representatives.

A method of recommending primary competitor list in case of not finding even indirect signal of competitor from the calls log and email database, the method having:

The one or more server processing units use the trained machine learning model to crawl the external public server and search for competitor that are looking for sales opportunities that are similar to the current sales opportunities of the sales representative;

In case the trained machine learning model found competitor that are looking for sales opportunities that are similar to the current sales opportunities of the sales representative, then add that competitor to primary competitor list; and

Thus the one or more server processing units execute computer-readable instructions and recommend a primary competitor list using indirect signal to sales representative on one or more sales representative devices, which improves the chances of winning a potential customer.

In an embodiment, the external public server is a public internet that hosts different web pages that are being crawled by the machine learning model of the one or more server processing units to extract data of competitors related to sales opportunities.

In an embodiment, on receiving a primary competitor list, if the sales representative found the primary competitor list is useful, then update same list on the on the customer relationship management database that is helpful to get direct signals from the customer relationship management database, and further the one or more server processing units primary competitor list.

In an embodiment, the one or more server processing units use data of both primary useful and non-useful competitors from primary competitor list to train machine learning models.

In an embodiment, the one or more sales representative devices includes, but not limited to, a desktop computer, a laptop, a tablet, a smartphone, a mobile phone.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A method for automated recommendations of competitors for sales opportunities based on business scenario, custom input and user feedback, the method comprising:
a method of recommending primary competitor list using direct signal from a customer relationship management database (102), and an enterprise resource planning database (110), the method having
an at least one server processing unit (106) of a system serve 104), executes computer-readable instructions that retrieve data related to historical sales opportunities from the customer relationship management database (102), the CPQ system (116) and the enterprise resource planning database (110),
the at least one server processing unit (106) executes computer-readable instructions to identify a list of sales opportunities from the historical sales opportunities that are similar to the current sales opportunities,
the at least one server processing unit (106) executes computer-readable instructions to find list of competitors from the identified list of sales opportunities from the historical sales opportunities that are similar to the current sales opportunities,
in case there is more than one competitors in the list of competitors, then that one competitor is categorized as primary competitor that has majority count in list of sales opportunities from the historical sales opportunities that are similar to the current sales opportunities, and further primary competitor is added to a primary competitor list,
in case there is only one competitor in the list, then that one competitor is added as primary competitor to the primary competitor list, and
thus the at least one server processing unit (106) executes computer-readable instructions and recommend primary competitor list using direct signal to sales representative on an at least one sales representative device (112), that improves the chances of winning a potential customer;
wherein, the at least one server processing unit (106) uses multiple similarity measures, classification and clustering algorithms identify a list of sales opportunities from the historical sales opportunities that are similar to the current sales opportunities,
a method of recommending primary competitor list in case of no direct signal of competitors are found in the customer relationship management database (102), CPQ system (116) and the enterprise resource planning database (110), the method having
the at least one server processing unit (106) of the system server (104) executes computer-readable instructions to retrieve data related to historical sales opportunities from a customer relationship management database (102), CPQ system (116) and an enterprise resource planning database (110), and feed into the trained machine learning model,
the at least one server processing unit (106) uses the trained machine learning model to analyze retrieve data to find indirect signal of one or more competitors in the historical sales opportunities that are similar to current sales opportunities,
in case the trained machine learning model finds indirect signal of one or more competitors, then that one competitor out of one or more competitors is categorized as primary competitor that has majority count in list of sales opportunities from the historical sales opportunities that are similar to the current sales opportunities, and further primary competitor is added to primary competitor list, and
thus the at least one server processing unit (106) executes computer-readable instructions and recommends primary competitor list using indirect signal to sales representative on an at least one sales representative device (112), that improves the chances of winning a potential customer;
a method of recommending primary competitor list in case of not finding even indirect signal of competitor from the customer relationship management database (102), CPQ system (116) and the enterprise resource planning database (110), the method having
the at least one server processing unit (106) uses the trained machine learning model retrieve data related to a historical conversation on emails and calls with customers from the calls log and email database (108),
the at least one server processing unit (106) uses the trained machine learning model to analyze data related to a historical conversation on emails and calls with customers to find indirect signal of one or more competitors
in case the trained machine learning model finds indirect signal of one or more competitors, then that one competitor, out of one or more competitors, is categorized as primary competitor that has majority count, and further primary competitor is added to primary competitor list, and
thus the at least one server processing unit (106) executes computer-readable instructions and recommends primary competitor list using indirect signal to sales representative on an at least one sales representative device (112), that improves the chances of winning a potential customer;
a method of recommending primary competitor list in case of not finding even indirect signal of competitor from the calls log and email database (108), the method having
the at least one server processing unit (106) uses the trained machine learning model to crawl the external public server (114) and search for competitor that are looking for sales opportunities that are similar to the current sales opportunities of the sales representative;
in case the trained machine learning model found competitor that are looking for sales opportunities that are similar to the current sales opportunities of the sales representative, then add that competitor to primary competitor list, and
thus the at least one server processing unit (106) executes computer-readable instructions and recommends primary competitor list using indirect signal to sales representative on an at least one sales representative device (112), that improves the chances of winning a potential customer.

2. The method as claimed in claim 1, wherein, data that are being extracted from the customer relationship management database (102), CPQ system (116) and the enterprise resource planning database (110), are selected from, but not limited to, a historical record of historical and current sales opportunities data, direct as well as indirect signals from CPQ systems.

3. The method as claimed in claim 1, wherein, data that are being extracted from the calls log and email database (108) are selected from, but not limited to, email and call recordings of sales representatives.

4. The method as claimed in claim 1, wherein, the at least one server processing unit (106) uses multiple similarity measures, classification and clustering algorithms identify a list of sales opportunities from the historical sales opportunities that are similar to the current sales opportunities.

5. The method as claimed in claim 1, wherein, the external public server (114) is a public internet that hosts different web pages that is being crawled by the machine learning model of at least one server processing unit (106) to extract data of competitors related to sales opportunities.

6. The method as claimed in claim 1, wherein, on receiving primary competitor list, if the sales representative found primary competitor list is useful, then update same list on the on the customer relationship management database (102) that is helpful to get direct signals from the customer relationship management database (102) and further the at least one server processing unit (106) primary competitor list.

7. The method as claimed in claim 6, wherein, the at least one server processing unit (106) uses data of both primary useful and non-useful competitor from primary competitor list to train machine learning model.

8. The method as claimed in claim 1, wherein, the at least one sales representative device (112) is selected from, but not limited to, a desktop computer, a laptop, a tablet, a smartphone, a mobile phone.

9. A system (100) for automated recommendations of competitors for sales opportunities based on business scenario, custom input and user feedback, the system (100) comprising:
a customer relationship management database (102), the customer relationship management database (102) stores all data related to the company's historical deals and have direct signal of competitor in particular sales opportunities;
a calls log and email database (108), the calls log and email database (108) stores all data related to a historical conversation on emails and calls with customers and have indirect signal of competitor;
an enterprise resource planning database (11.0), the enterprise resource planning database (110) stores all data related to the company operations management;
an external public server (114);
a CPQ system (116);
an system server (104), the system server (104) having
the at least one server processing unit (106), the at least one server processing unit (106) executes computer-readable instructions to receive direct signal and indirect signal of competitor related to particular sales opportunities from customer relationship management database (102) and the enterprise resource planning database (110), and further the at least one server processing unit (106) uses the trained machine learning model to receive indirect signal of competitor related to particular deal from the calls log and email database (108), wherein, in case no competitor references are found in above method, then the at least one server processing unit (106) uses the trained machine learning model to extract data of competitor related to particular deal form the external public server (114),
the server memory (120), the server memory (120) stores computer-readable instructions and machine learning model; and
the at least one sales representative device (112), the at least one sales representative device (112) is connected to the system server (104), a user receives list of competitor related to particular deal;
wherein, the customer relationship management database (102), the call log, and email database (108), the enterprise resource planning database (110), are all connected to the system server (104).

10. The external public server (114) as claimed in claim 9, wherein, the external public server (114) is public internet that hosts different web pages that are being crawled by the machine learning model of the at least one server processing unit (106) to extract data of competitors related to sales opportunities.
